(19) United States
(12) Patent Application Publication
(10) Pub. No.: US 2006/0182864 A1
(43) Pub. Date: Aug. 17, 2006

(54) Cookies comprising dietary fiber gel

(75) Inventors: Triveni P. Shukla, New Berlin, WI (US); Gregory J. Halpern, Vernon Hills, IL (US)

Correspondence Address: Timothy J. Fullin, 1011 Campus Drive, Mundelein, IL, 60060, US

(73) Assignee: Circle Group Holdings, Inc.

(21) Appl. No.: 11/403,429

(22) Filed: Apr. 13, 2006

Related U.S. Application Data
(63) Continuation-in-part of application No. 10/878,914, filed on Jun. 28, 2004, now abandoned.

(51) Int. Cl. A21D 10/00

(52) U.S. Cl. 426/549

(57) ABSTRACT

According to the present invention, fat and caloric content of cookies can be reduced by the replacement of a portion fat content normally found in cookies with an amount of dietary fiber. The result is that fat and caloric content of cookies can be manipulated with minimal effect on taste and texture. Furthermore, the cookies can further comprise functional foods that increase health and nutritional benefits of the cookies. The functional foods can be added individually, and in any combination thereof. Hence, in addition to reducing fat and caloric content of cookies by replacing a portion of fat with dietary fiber gel, additional health benefits can be achieved with compositions that include functional foods.

### CROSS-REFERENCE TO RELATED APPLICATIONS

This application is a Continuation in Part Application of U.S. patent application Ser. No. 10/878,914 filed on Jun. 28, 2004, which is incorporated in its entirety by reference herein.

### STATEMENT REGARDING FEDERALLY SPONSORED RESEARCH/DEVELOPMENT

The present invention does not involve any form of federally sponsored research or development.

### BACKGROUND OF THE INVENTION

The present invention relates to cookies comprising dietary fiber gel. Recent media attention to the global problem of obesity demonstrates a need for greater availability of foods with low caloric and fat content. This is especially true for foods that typically have high fat and caloric content, such as cookies.

Cookies typically comprise some combination of flour, butter or margarine, and sugar. Other ingredients can vary according to the type of cookie and the recipe followed, but typically, cookies are high in both fat and caloric content.

In recent years, some companies have begun to offer reduced fat cookies. This variety of cookie, however, often involves increased sugar concentrations in order to compensate for the less desirable taste resulting from lower fat concentrations and frequently fails to retain the desirable taste and texture of cookies comprising higher fat contents.

Accordingly, there is a need for reduced fat and caloric content cookies that have the desirable flavor and texture of high fat and high caloric content cookies.

### BRIEF SUMMARY OF THE INVENTION

A composition of matter for use in producing high-fiber, low-calorie and low-fat cookies is provided. The composition includes dietary fiber gel that replaces fat in cookies. In addition, compositions are provided that include dietary fiber gel and other functional ingredients for nutritionally fortified cookies.

### DETAILED DESCRIPTION OF THE PREFERRED EMBODIMENT

The following description provides for the use of dietary fiber gels for fat and calorie reduced cookies. Dietary fiber gels for calorie-reduced foods hold the key to meeting this need. Dietary fiber gels for calorie-reduced foods are fully described in U.S. Pat. No. 5,766,662 (the '662 patent), which is herein incorporated by reference in its entirety. These dietary fiber gels comprise insoluble dietary fibers consisting of morphologically disintegrated cellular structures, and are characterized by their ability to retain large amounts of water. These amorphous insoluble cellulosic fiber gels are produced by shearing agricultural by-products, such as seed brans, hulls, and so forth, under alkaline conditions. Amorphous insoluble cellulosic fiber gels in a hydrated form can exist as gel, and in the dehydrated form as flakes and powders. Additionally, their high viscosity at low solid levels characterizes these dietary fiber gels. Other insoluble fibers derived from cereals, grains and legumes consist of morphologically in tact cellular structures, and thus impart a gritty texture to the foods in which they are contained. The amorphous insoluble cellulosic fiber gels disclosed in the '662 patent (also herein referred to as dietary fiber gels), however, are amorphous in nature and consist of morphologically disintegrated cellular structures; they thus impart a smoother texture than other insoluble fiber formulations. The physically smooth morphology is readily revealed under electron microscopic magnification of amorphous insoluble cellulosic fiber gel. The smooth morphology is also demonstrated by approximately 60 percent to 90 percent reduction in birefringence when compared to microcrystalline dietary fiber products. The smooth morphology reflects the amorphous nature of the insoluble compounds that constitute amorphous insoluble cellulosic fiber gel.

Dietary fiber gels are fully described in U.S. Pat. No. 5,766,662 (the '662 patent). These dietary fiber gels comprise insoluble dietary fibers consisting of morphologically disintegrated cellular structures, and are characterized by their ability to retain large amounts of water. Dietary fiber gel can be a gellable product or a gel powder depending on water content. Typically, dietary fiber gel is produced as a gellable product that is dried to remove water so as to produce a gel powder having reduced water content. Dietary fiber gels are characterized by high hydration capacity when reconstituted with water. Additionally, these dietary fiber gels are characterized by their high viscosity at low solid levels. Other insoluble fibers derived from cereals, grains and legumes derived by conventional dry milling consist of morphologically in tact cellular structures, and thus impart a gritty texture to the foods in which they are contained. The dietary fiber gels disclosed in the '662 patent, however, consist of morphologically disintegrated cellular structures and thus impart a smoother texture than other insoluble fiber formulations.

According to the present invention, fat and caloric content can be reduced by the replacement of the fat-containing ingredients normally found in cookies with dietary fiber gel. Substituting dietary fiber gel for fat does not adversely affect either the taste or texture of the cookies.

Alternatively, the cookies can be provided in the form of cookie mixes with the intention that a consumer can mix and bake them at a convenient, post-purchase time, and cookie mixes are considered to be within the scope of this invention. Similarly, cookies can also be provided in the form of cookie dough with the intention that a consumer can bake them at a convenient, post-purchase time, and cookie dough is considered to be within the scope of this invention. Also, cookies can be of a low or high moisture type. As such, for purposes of this document, the term “cookies” is defined to include cookie mixes, cookie dough, and low or high moisture type cookies.

The different categories of cookies available to consumers can be formulated such that the cookies have reduced fat and calories. Cookies can be formulated such that the cookies comprise 0.25 percent to 8.0 percent dietary fiber gel solids by replacing an appropriate amount, that is, prorated to deliver this range of dietary fiber gel solids, of fat, such as included in oil and liquid shortening. The result is that fat and caloric content of cookies can be manipulated with minimal effect on taste and texture, and as stated above, additional health benefits can be achieved through consumption of cookies comprising dietary fiber gel when functional foods are included in the formulations.

Functional ingredients can be added to the composition of cookies to increase health and nutritional benefits of this food. Most notably functional foods such as high omega three and omega six oils and pure omega three and omega six fatty acids, medium chain triglyceride, beta carotene, calcium stearate, vitamin E, bioflavonoids, fagopyritrol, polyphenolic antioxidants of vegetable origin, lycopene, luteine and soluble fiber, for example Beta-Glucan derived from yeast, and other soluble fibers derived from grain, flax seed, and other vegetable and fruit fiber sources can be added to cookies.

The following ranges of the functional foods in cookies are given by way of example, but other functional foods, notably fat soluble functional foods, can be added as well. High omega three oils and omega six oils, for example flax seed oil, can be added in concentrations of 1 percent to 50 percent of the composition by weight. Pure omega three fatty acids and omega six fatty acids can be added in concentrations ranging from 1 percent to 30 percent of the composition by weight. If both pure omega three or six fatty acids and high omega three oils are used, their respective concentrations can be prorated to give an appropriate end concentration of high omega three fatty acids. Medium chain triglyceride can be added in concentrations ranging from 1 percent to 30 percent of the composition by weight. Fagopyritrol or foods containing fagopyritrol can be added in concentrations of 0.25 percent to 20 percent of the composition by weight. Polyphenolic antioxidants of vegetable origin, for example lycopene, beta carotene, luteine, and bioflavonoids can be added in concentrations ranging from 0.25 percent to 20 percent of the composition by weight. Soluble fiber, for example beta Glucan, can be added in concentrations ranging from 5 percent to 15 percent of the composition by weight. Any functional foods added to the composition can be added in such concentrations to deliver up to 100 percent, preferably 25 percent to 100 percent, of prevailing recommended daily intake recommendations by the FDA (Food and Drug Administration of the United States), European Commission, and reported by the FAO (Food and Agricultural Organization of the United Nations) in the Codex Alimentarius, or other international authorities.

Although the present invention is illustrated by the example of cookies, cookie dough, cookie mixes, and so forth, the present invention applies to foods and food formulations that include fat containing ingredients such as oils, greases, and lards that are derived from vegetable, animal, or synthetically produced that are used in the mixing, baking, reheating or other processing as necessary to produce edible foods.

An advantage of the present invention is the ability to provide a unique composition of matter embodied by low-calorie and low-fat cookies. The fat and caloric content are advantageously reduced by the replacement of the fat normally found in cookies with compositions comprising dietary fiber gel. Food compositions that reduce caloric and fat content answer an unmet need in the food industry to provide the consuming public with a healthier, higher fiber alternative to traditional types of cookies that typically are inherently fattening. Another advantage is the providing cookies that have been fortified with insoluble fiber and other functional foods. Yet another advantage is that the fat replacement with dietary fiber gel does not adversely affect either the taste or texture of cookies. Finally, the fat and caloric content of cookies can be advantageously manipulated with minimal adverse effect on taste and texture, and additional health benefits can be achieved through composition of cookies comprising dietary fiber gel when functional foods are included in the formulations.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

### EXAMPLE

COOKIE

| | Original | | Experimental Formulas, % | |
|---|---|---|---|---|
| Ingredient | LB | % | % | Remarks |
| Shortening, | 150 | 22.17 | 12.17 | |
| 100% Fat | | | | |
| Sugar | 150 | 22.17 | 24.17 | |
| Eggs, 11% Fat | 45 | 6.65 | 5.00 | |
| Water | 30 | 4.43 | 14.09 | This could be 3.55% to 4.00% |
| | | | | FiberGel |
| Baking Soda | 1.5 | 0.22 | 0.35 | |
| Flour | 300 | 44.36 | 44.00 | |
| Dietary | — | | 0.50 | 0.50 parts Z-trim powder in |
| Fiber Gel | | | | 14.09 parts water makes 3.55% |
| | | | | Gel. |
| % FAT | | 22.90 | 12.72 | |

Procedure
1. Mix Z-trim in water in a high-speed blender. Pulse twice in order to wet all z-Trim.
2. Blend at high speed for at least three minutes, at least one more minute past the time of max. resistance experienced by the motor.
3. Add shortening and mix well.
4. Add eggs and mix well.
5. Blend sugar, flour and baking soda separately and then use the liquid blend into solids to make the dough.

I claim:

1. Cookies, the cookies having a formulation, the cookies comprising dietary fiber gel, wherein dietary fiber gel is added in a prorated amount such that solids contained within the dietary fiber gel represent 0.25 percent to 7.0 percent by weight of the overall cookie formulation, and dietary fiber gel replaces an amount of fat used in an otherwise identical recipe of cookies that uses no dietary fiber gel.

2. Cookies of claim 1, wherein the cookies are made from a cookie mix.

3. Cookies of claim 1, wherein the cookies are made from cookie dough.

4. Cookies of claim 1, further comprising at least one functional food and combinations thereof selected from a group consisting of
high omega three oil, wherein high omega three oil represents 1 percent to 50 percent of the cookies by weight,
pure omega three fatty acid, wherein pure omega three fatty acid represents 1 percent to 30 percent of the cookies by weight,
a combination of high omega three oil and pure omega three fatty acid, wherein the total omega three fatty acid present in the combination represents 1 percent to 30 percent of the cookies by weight,
medium chain triglyceride, wherein medium chain triglyceride represents 1 percent to 30 percent of the cookies by weight,
fagopyritrol, wherein fagopyritrol represents 0.25 percent to 20 percent of the cookies by weight,
lycopene, wherein the lycopene represents 0.25 percent to 20 percent of the cookies by weight,
polyphenolic antioxidants of vegetable origin, wherein polyphenolic antioxidants represent 0.25 percent to 20 percent of the cookies by weight,
luteine, wherein the luteine represents 0.25 percent to 20 percent of the cookies by weight, beta carotene, wherein the beta carotene represents 0.25 percent to 20 percent of the cookies by weight,
calcium stearate, wherein the calcium stearate represents 0.25 percent to 20 percent of the cookies by weight,
vitamin E, wherein the vitamin E represents 0.25 percent to 20 percent of the cookies by weight, and
bioflavonoid, wherein the bioflavonoid represents 0.25 percent to 20 percent of the cookies by weight.

5. Cookies of claim 1, further comprising at least one functional food and combinations thereof selected from a group consisting of high omega three oil; pure omega three fatty acid; a combination of high omega three oil and pure omega three fatty acid; medium chain triglyceride; fagopyritrol; lycopene; polyphenolic antioxidants of vegetable origin; luteine; beta carotene; calcium stearate; vitamin E; and bioflavonoid, wherein the cookies deliver at least 25% of the recommended daily intake of the functional food as reported by the United States Food and Drug Administration.

6. Cookies of claim 5, wherein the cookies deliver the recommended daily intake of the functional food as reported by the United States Food and Drug Administration.

7. Cookies of claim 1, further comprising at least one functional food and combinations thereof selected from a group consisting of high omega three oil; pure omega three fatty acid; a combination of high omega three oil and pure omega three fatty acid; medium chain triglyceride; fagopyritrol; lycopene; polyphenolic antioxidants of vegetable origin; luteine; beta carotene; calcium stearate; vitamin E; and bioflavonoid, wherein the cookies deliver at least 25% of the recommended daily intake of the functional food as reported by the European Commission.

8. Cookies of claim 7, wherein the cookies deliver the recommended daily intake of the functional food as reported by the European Commission.

9. Cookies of claim 1, further comprising at least one functional food and combinations thereof selected from a group consisting of high omega three oil; pure omega three fatty acid; a combination of high omega three oil and pure omega three fatty acid; medium chain triglyceride; fagopyritrol; lycopene; polyphenolic antioxidants of vegetable origin; luteine; beta carotene; calcium stearate; vitamin E; and bioflavonoid, wherein the cookies deliver at least 25% of the recommended daily intake of the functional food as reported by the FAO (Food and Agriculture Organization of the United Nations) in the Codex Alimentarius.

10. Cookies of claim 9, wherein the cookies deliver the recommended daily intake of the functional food as reported by the FAO (Food and Agriculture Organization of the United Nations) in the Codex Alimentarius.
